(19) United States
(12) Patent Application Publication
(10) Pub. No.: US 2004/0190315 A1
(43) Pub. Date: Sep. 30, 2004

(54) D.C.-A.C. converting circuit capable of increasing boosting efficiency and reducing noise

(75) Inventor: Jacky Peng, Chung Ho City (TW)

Correspondence Address: BACON & THOMAS, PLLC, 625 SLATERS LANE, FOURTH FLOOR, ALEXANDRIA, VA, 22314

(73) Assignee: SEMISILICON TECHNOLOGY CORP., Chung Ho City (TW)

(21) Appl. No.: 10/396,442

(22) Filed: Mar. 26, 2003

(51) Int. Cl. H02M 3/24

(52) U.S. Cl. 363/95

(57) ABSTRACT

D.C.-A.C. converting circuit capable of increasing boosting efficiency and reducing noise, including a boosting section composed of serially connected transistors, inductors and capacitors and an A.C. electronic switch part composed of several transistors (electronic switches such as MOSFET, gate throttle, etc.) and capacitors. When the signal for controlling the operation of the transistors is boosted from low potential to high potential, the operation of the transistors is speeded. When cut off, the signal is formed with a negative voltage level pattern, whereby the transistors can be more quickly cut off. The electronic switch part of the circuit is replaceable with several serially connected diodes to also achieve the voltage for increasing boosting efficiency. During discharge, a measure for controlling the current of the circuit is added so as to reduce the noise produced during boosting procedure.

### BACKGROUND OF THE INVENTION

The present invention is related to a D.C.-A.C. converting circuit applicable to electronic parts such as electroluminescent cells. During the conversion of the electronic parts from low voltage D.C. to high voltage A.C., the circuit of the present invention is able to overcome the inherent voltage barrier problem and effectively enhance output voltage.

Various electroluminescent cells (EL) have been developed and widely used in various fields. However, the D.C.-A.C. converting circuit for driving the electroluminescent cell is still not optimal and needs to be improved. A prior technology discloses a circuit structure (as shown in FIG. 1) for driving the electroluminescent cell. The circuit is a full-wave A.C. boosting circuit. The left side of the phantom line is boosting part, while the right side of the phantom line is a switch part forming alternate current. A high voltage signal is formed at point H. However, when passing through the switch part, due to the inherent voltage barrier problem of the electronic parts, the highvoltage at point Hwill about 10˜30% decay. As a result, the efficiency will be discounted. With respect to the above problem, it is found by the applicant that in fact, the “on/off” of the transistor (electronic switch) is activated by the signal of the controlling end. The speed of the electronic switch is an important factor of the efficiency of boosting. When turning from “on” to “off”, the shorter the activation time is, the higher the high voltage signal energized by the inductance is, that is, the better the efficiency is. In general control, in the case that the signal A is high potential, Q1 is powered on, while in the case that the signal A is low potential, Q1 is cut off. However, the existence of parasitic capacity in Q1 and the operation rate of Q1 itself limit the output thereof. By means of speeding the cutoff of Q1, the output of Q1 will be effectively enhanced. This measure is applicable to half-wave structure as shown in FIG. 2 and to full-wave boosting structure as shown in FIGS. 1 and 3 to effectively enhance output voltage.

The above-identified prior technology discloses a circuit structure for driving the electroluminescent cell as shown in FIG. 3. U.S. Pat. No. 650,228 discloses a circuit structure for driving the electroluminescent cell as shown in FIG. 4. FIG. 5 shows a part for controlling signal waveform. According to the aforesaid concept, in the case that the controlling signals A, B are modified into the pattern as shown in FIG. 6, the efficiency will be about 20˜30% increased.

### SUMMARY OF THE INVENTION

It is therefore a primary object of the present invention to provide a D.C.-A.C. converting circuit capable of increasing boosting efficiency.

It is a further object of the present invention to provide the above D.C.-A.C. converting circuit capable of reducing the noise caused by the electronic switch.

The present invention can be best understood through the following description and accompanying drawings wherein:

### BRIEF DESCRIPTION OF THE DRAWINGS

FIG. 1 is a circuit diagram of a conventional full-wave boosting circuit (Prior Art);

FIG. 2 is a circuit diagram of a conventional half-wave boosting circuit (Prior Art);

FIG. 3 is a circuit diagram of another type of conventional full-wave boosting circuit, showing the switch part thereof (Prior Art);

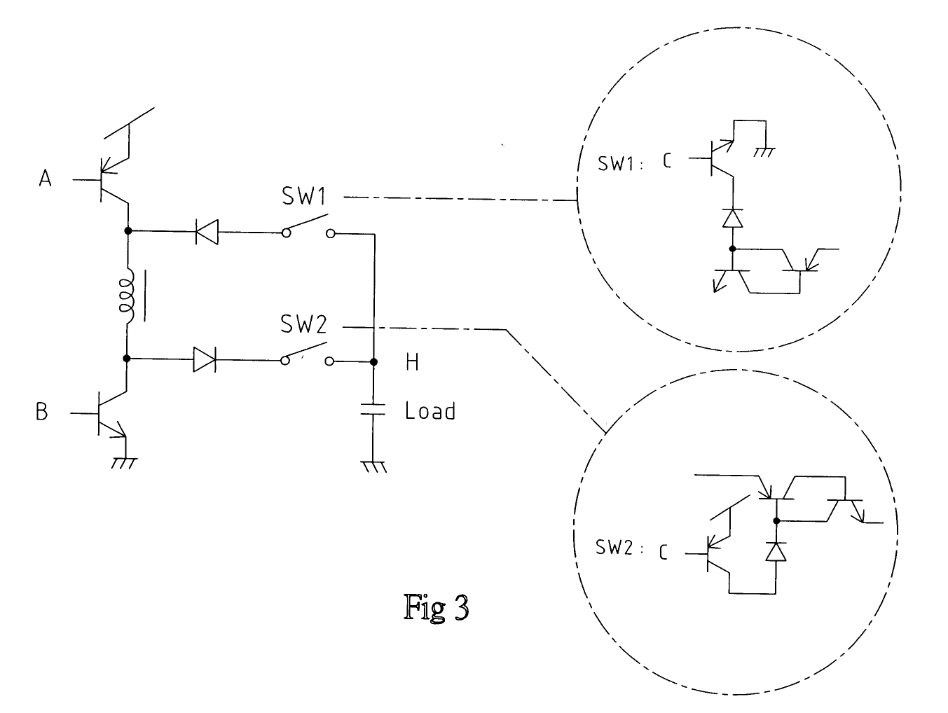

FIG. 4 is a circuit diagram of still another conventional full-wave boosting circuit (Prior Art);

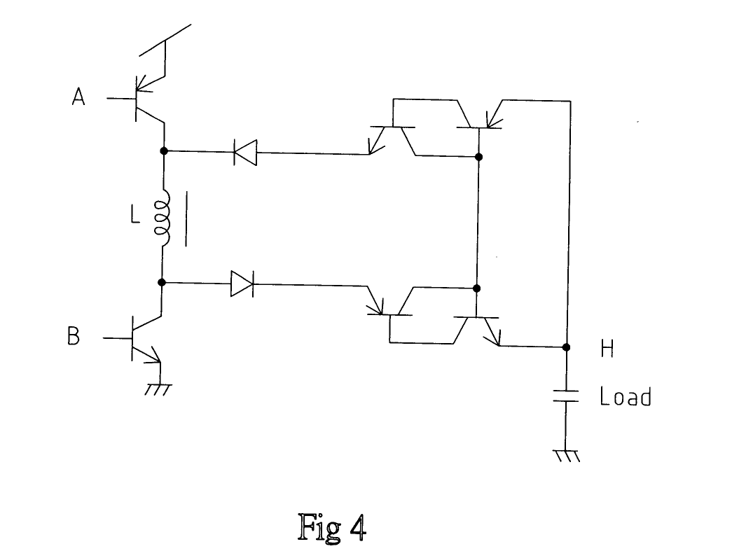

FIG. 5 is a diagram of a waveform of the controlling signal according to FIG. 3;

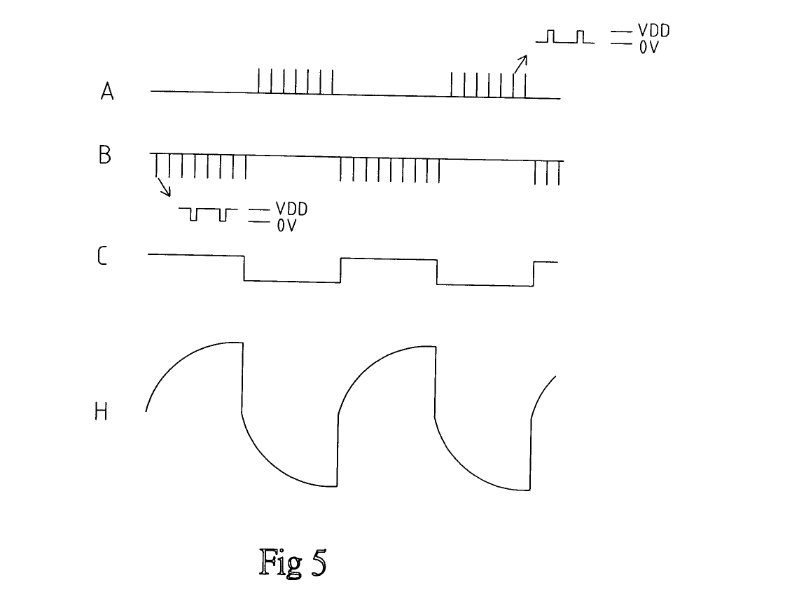

FIG. 6 is a diagram of another waveform of the controlling signal according to FIG. 3;

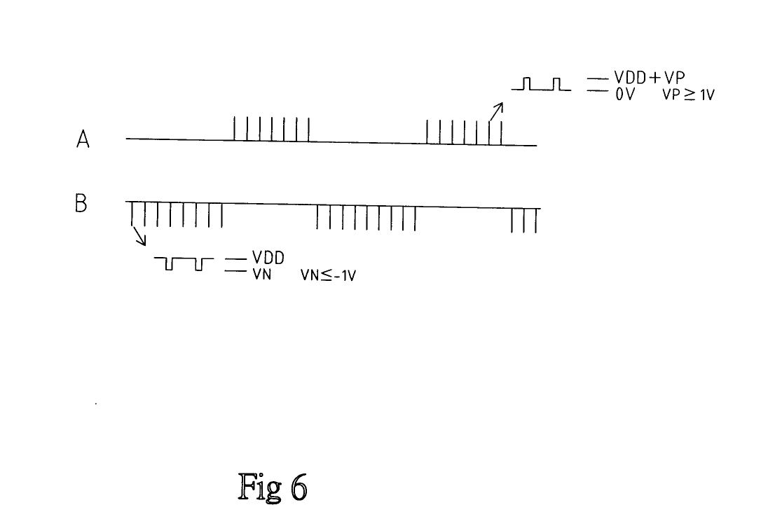

FIG. 7 is a circuit diagram of a preferred application of the present invention;

FIG. 8 is a diagram of a waveform of the controlling signal according to FIG. 7;

FIG. 9 is a circuit diagram of another preferred application of the present invention;

FIG. 10 is a diagram of a waveform of the controlling signal according to FIG. 9;

FIG. 11 is a diagram of a conventional waveform of the high voltage A.C. signal of a loading;

FIG. 12 is a diagram of another waveform of the high voltage A.C. signal for driving a loading of the present invention;

FIG. 13 is a diagram of still another waveform of the high voltage A.C. signal for driving a loading of the present invention;

FIG. 14 is a circuit diagram of still another preferred application of the present invention;

FIG. 15 is a diagram of the controlling signal and output waveform according to FIG. 14;

FIG. 16 is a diagram of a modified waveform applying the structure of FIG. 2;

FIG. 17 is a diagram of another modified waveform applying the structure of FIG. 2;

FIG. 18 is a circuit diagram of still another preferred application of the present invention;

FIG. 19 is a circuit diagram of a conventional controlling circuit;

FIG. 20 is a diagram of still another waveform of the high voltage A.C. signal for driving a loading of the present invention;

FIG. 21 is a diagram of a modified waveform applying the structure of FIG. 8;

FIG. 22 is a diagram of a modified waveform applying the structure of FIG. 10;

FIG. 23 is a diagram of still another waveform of the high voltage A.C. signal for driving a loading of the present invention;

FIG. 24 is a circuit diagram of still another preferred application of the present invention;

FIG. 25 is a diagram of the switch circuit of a conventional full-wave boosting circuit; and

FIG. 26 is a diagram of a waveform of the controlling signal according to FIG. 25.

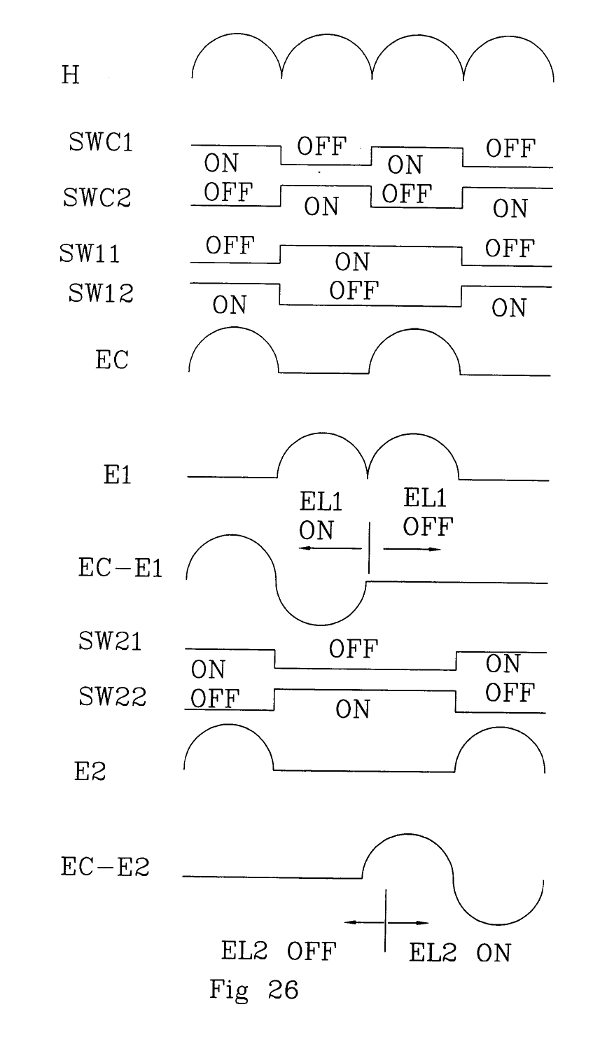

### DETAILED DESCRIPTION OF THE PREFERRED EMBODIMENTS

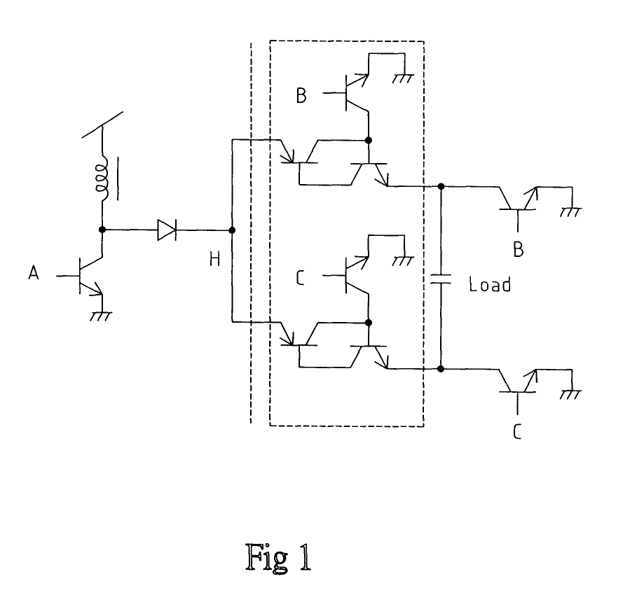

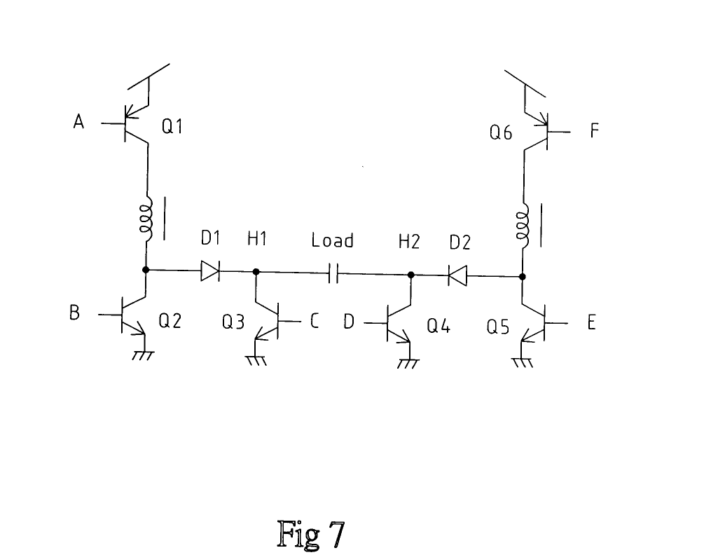

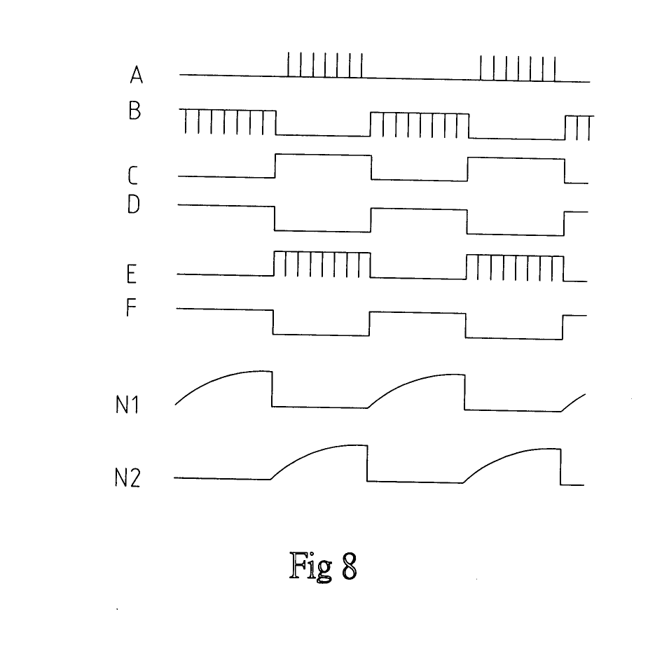

Please refer to FIG. 7. The capacitive loading D.C.-A.C. converting circuit capable of increasing boosting efficiency and reducing noise of the present invention includes several transistors Q1˜Q5, several diodes D1˜D2 and several cooperative electronic parts such as inductors and capacitors. Each of the left and right halves of the capacitive loading has a set of boosting circuit. When the left half works, the transistor Q4 is turned on, while Q5 is cut off and Q1 is turned on, while Q3 is cut off. After a period of time, the point H1 of the controlling signal B of Q2 (also referring to FIG. 8) will be boosted to a high voltage state. At this time, the transistor Q2 will stop operating. Q1 is cut off, while Q3 is turned on. The point H1 discharges through Q3 and is instantaneously lowered from high voltage to a nearly zero potential. Thereafter, the transistor Q4 is cut off, while Q6 is turned on and Q5 operates according to signal E. Further after a period of time, point H2 also reaches a high potential. Then Q4 is turned on, while Q6 is cut off and Q5 stops operating. The point H2 discharges and is lowered from high potential to a nearly zero potential. Accordingly, repeatedly, high voltage is sequentially generated at two ends of the capacitive loading to form a high voltage A.C. signal. This structure is advantageous in that the electronic switch in the phantom line frame of FIG. 1 is replaced with D1, D2 so that the signal added to the load will be more efficient.

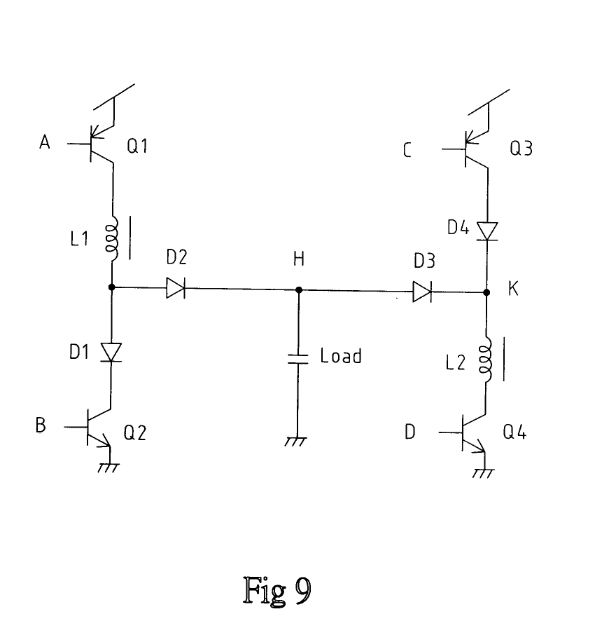

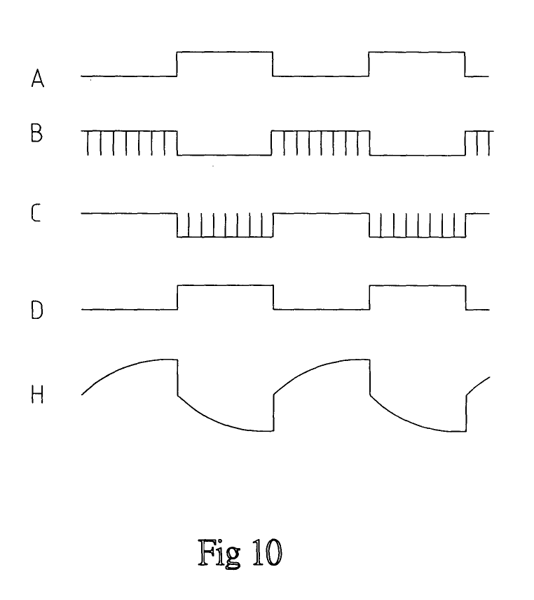

FIG. 9 shows another preferred embodiment of the circuit of the present invention, in which when Q3, Q4 are cut off, Q1 is turned on and Q2 operates according to the controlling signal B of FIG. 10. After a period of time, point H reaches a high voltage point and Q1, Q2 are cut off, while Q4 is turned on and Q3 operates according to controlling signal C. The point H first discharges through D3, L2, Q4 to a nearly zero potential. Then, due to the negative voltage boosting of L2 and Q3, after a period of time, point H reaches a high negative voltage. At this time, Q3, Q4 are cut off, while Q1 is turned on and Q2 operates. After point H is recharged from high negative voltage to zero potential, point H is further charged to high positive voltage. According to such cycle, a continuous high voltage A.C. signal is formed as shown in FIG. 10.

In the above circuit structure, D1 and D4 are mainly used to prevent the transistors from breaking. With respect to D4, when Q1, Q2 operate and Q3, Q4 are cut off, point H will have a high positive voltage signal and point K is also a high positive voltage signal. At this time, Q4 is in off state. Q4 is an NPN type transistor so that the collector C of Q4 can bear the high positive voltage to a certain extent without breaking. However, Q3 is a PNP type transistor so that the collector C of Q3 cannot bear the high positive voltage. Therefore, a diode D4 is added to prevent Q3 from breaking and thus avoid failure of high voltage. Similarly, D1 is added, for Q2 cannot bear high negative voltage. In addition, the measures of FIGS. 7 and 9 can be used in cooperation with the aforesaid measure for changing the level of the controlling signal into negative voltage or positive voltage greater than VDD so as to more effectively increase the whole efficiency.

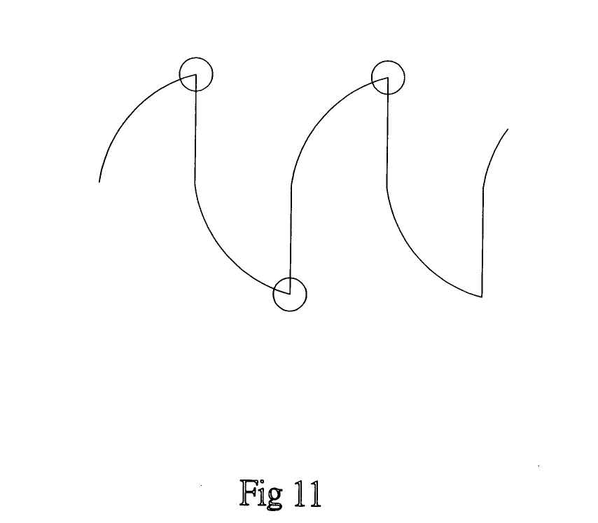

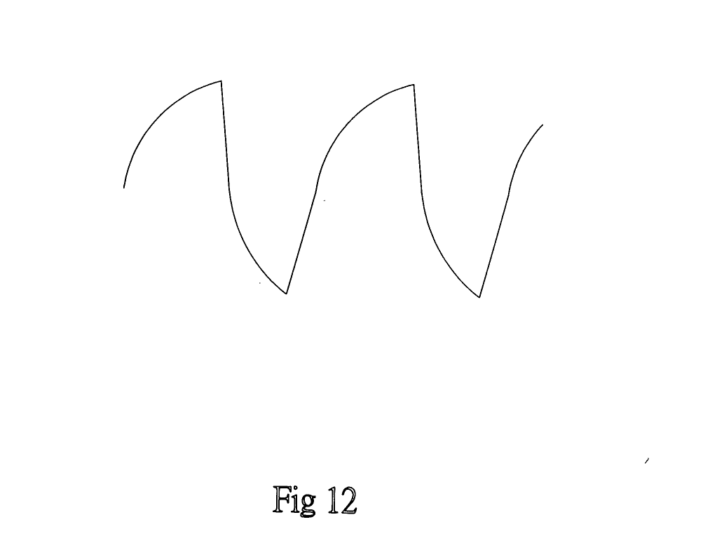

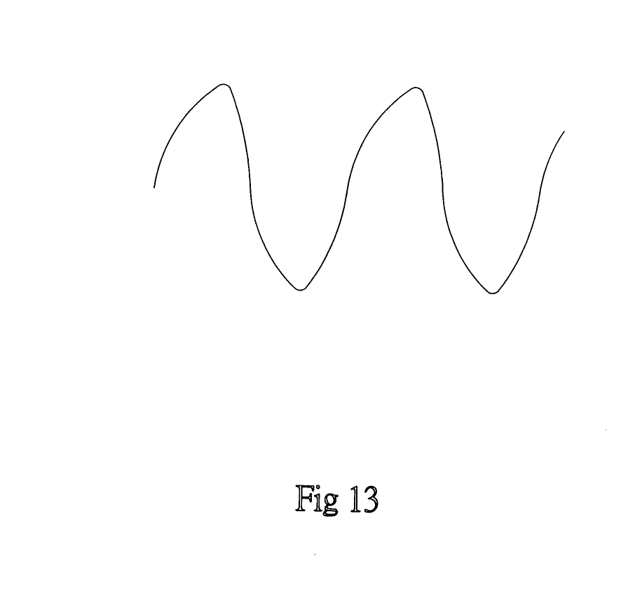

All the above circuit structures can boost low voltage D.C. signal into high voltage A.C. signal. However, there is still a problem existing in such circuit structures, that is, interference problem. In general, such driving structure is co-used with other IC or electronic parts. The boosting operation will lead to a high-frequency interference signal or even audible noise. In order to solve this problem, the above three circuit structures are further modified. FIG. 11 shows a driving high voltage A.C. signal of a loading. Such high voltage A.C. signal is achievable from the above three circuit structures. The circled part of FIG. 11 is the part which most often causes interference signal. The optimal waveform is sinusoidal wave. However, for achieving the optimal sinusoidal wave, a more complicated circuit structure is necessary. This is not desired. Therefore, the waveform of FIG. 11 can be simplified into the alternative waveform as shown in FIGS. 12 or 13.

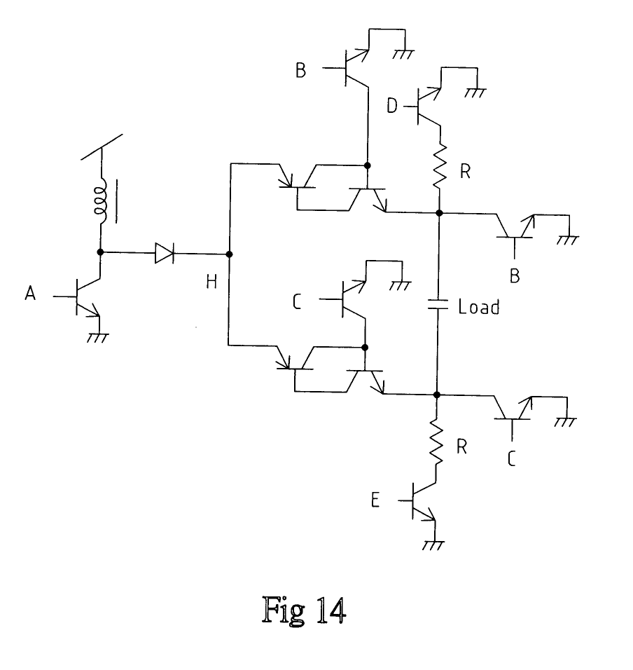

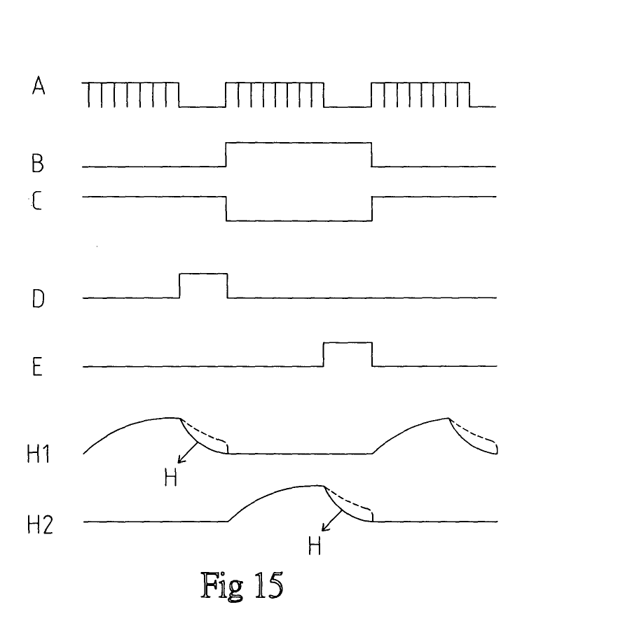

The conventional circuit structure of FIG. 1 can be such modified that only two resistors and two transistors are added as shown in FIG. 14 to achieve the waveform of FIG. 12. FIG. 15 shows the controlling signal and output waveform thereof.

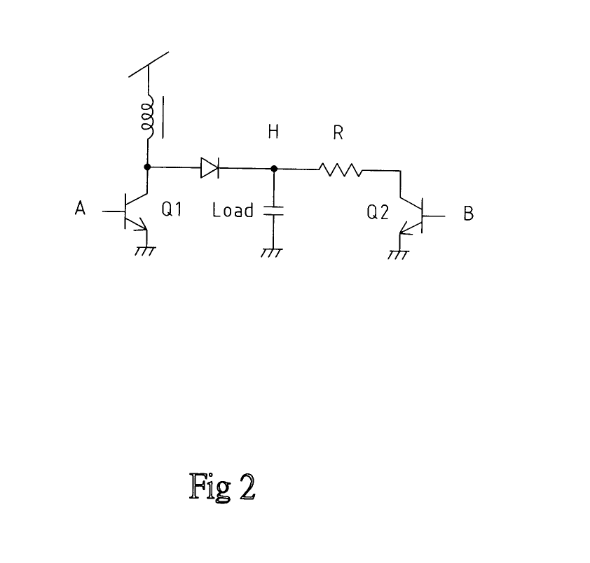

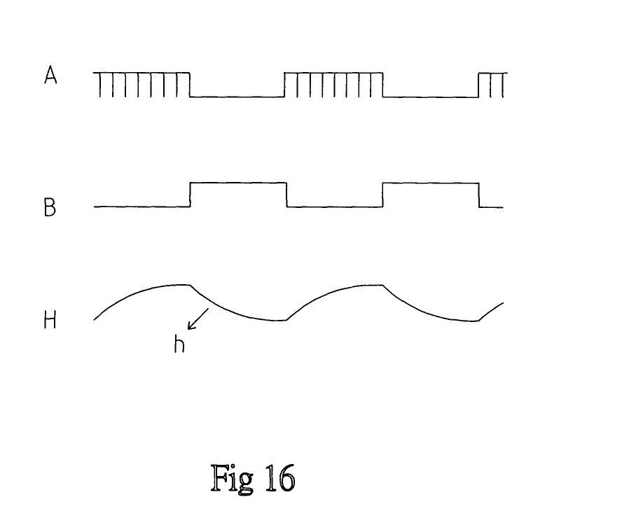

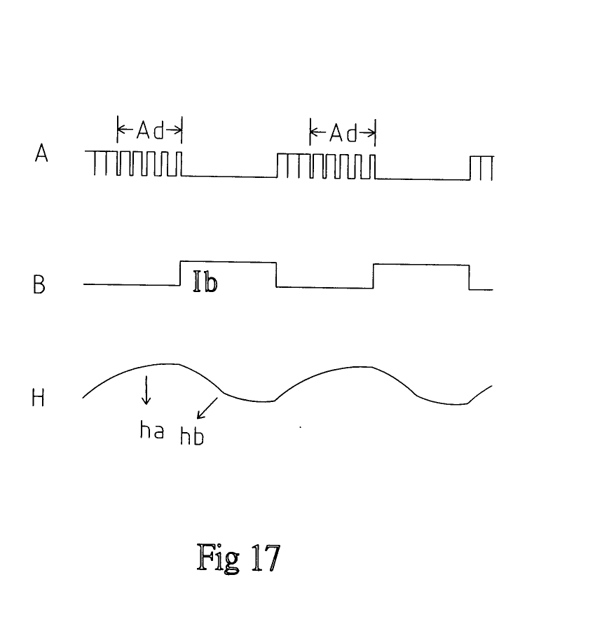

Furthermore, in FIG. 2, the R can be achieved by limiting the current when starting to discharge. The waveform is as shown in FIG. 16. The value of the Rwill determine the slope of the H. This concept is better than that when the value of the R is zero ( instantaneous discharge of capacitive loading ). However, it is still not optimal. The even better measure is to let R zero. By means of the signal B of FIG. 2 or the signals B and C of FIG. 14, which control and energize the transistors in cooperation with the change of bandwidth of signal A, the effect as shown in FIG. 17 can be achieved. Due to the change of bandwidth of Ad, the position Ha will become more smooth. The position Ib controls the magnitude of the discharged current to obtain the waveform of Hb. Accordingly, the waveform of h can be nearer to the sinusoidal wave. Therefore, the interference and noise of the capacitive loading such as electroluminescent cell can be reduced.

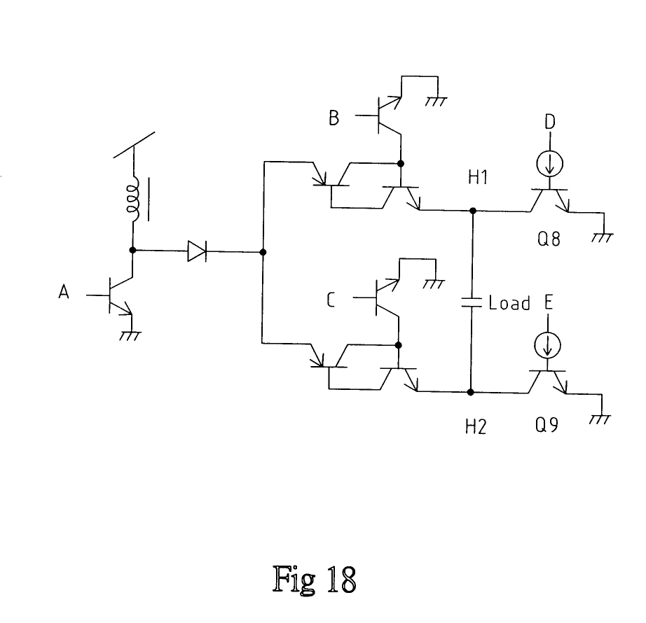

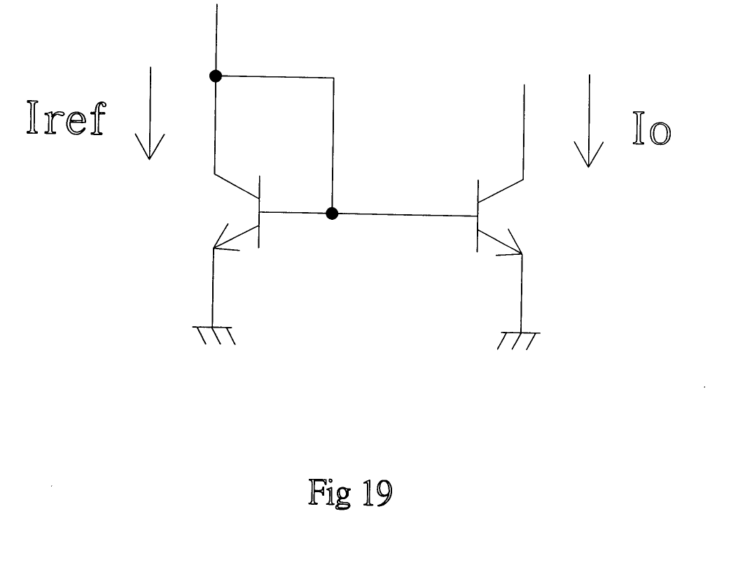

Furthermore, FIG. 18 shows a more idealistic measure for directly changing the current of the controlling signal and achieving the object without adding any extra part. When C=“H” ( high potential ) and E=“H”, H2 is equal to grounding, while when B=“L” (low potential) and D=“L”, after a period of time, H1 will be charged to high voltage. At this time, A stops sending signal and theoretically point H1 will remain in a high voltage state. At this time, D sends in a stable constant small current and Q8 is in a high impedance energized state. H1 slowly discharges through Q8 to obtain the waveform as shown in FIG. 12. Reversely, H2 is the same. Certainly, there are many measures for controlling the constant current. FIG. 19 shows an ordinary application in which Q8 or Q9 of FIG. 18 is controlled to discharge via constant current. Moreover, if the controlled current during the discharge is not constant and is slowly increased along with the time or the controlled current discharged through Q8 or Q9 is increased along with the time, the optimal waveform as shown in FIG. 13 can be achieved.

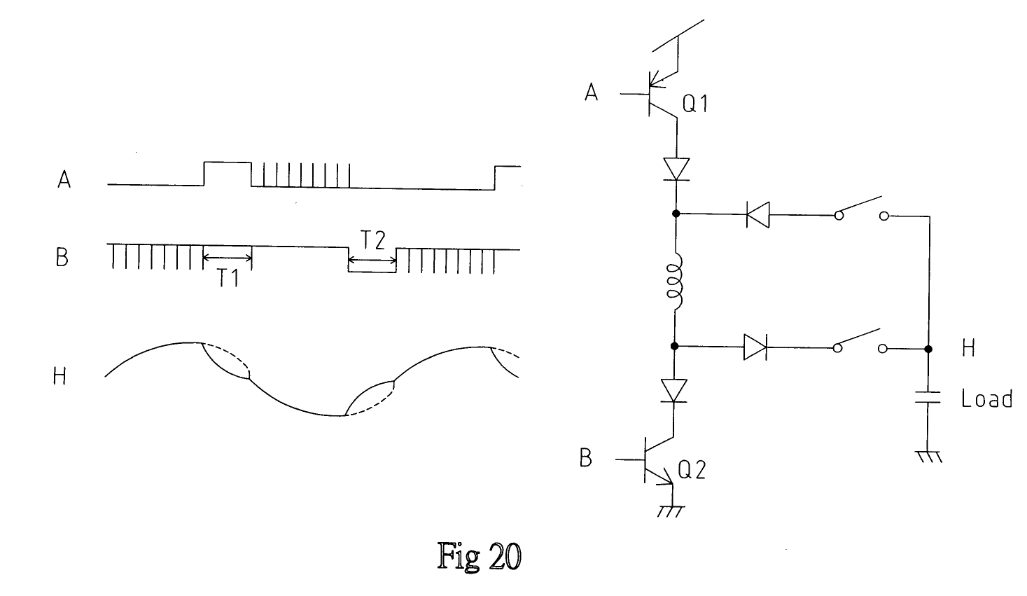

FIG. 20 is a diagram of the rectified controlling signal for reducing the interference of the circuit structure, in which T1 means that signal B is a constant small current and Q2 is in a high impedance energized state, while T2 means that signal A is a constant small current and Q1 is also in a high impedance energized state.

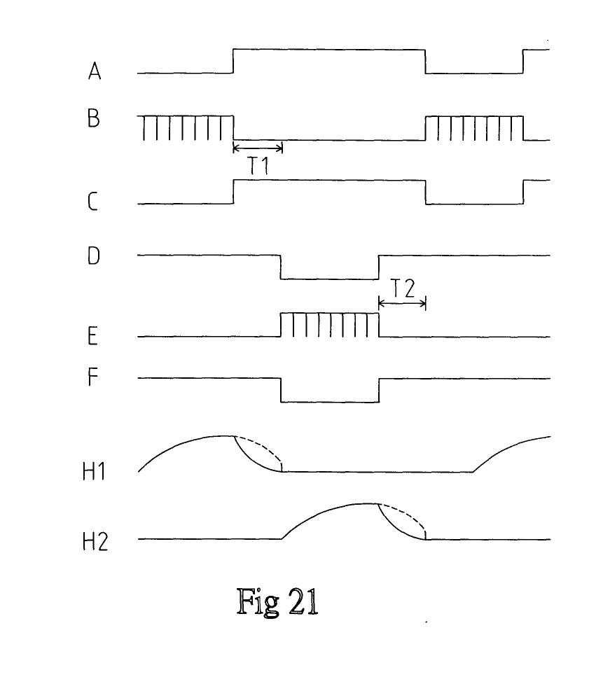

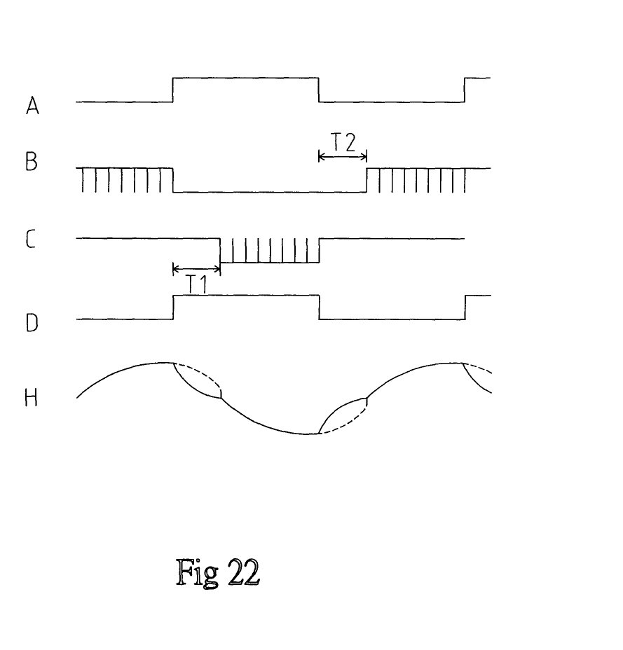

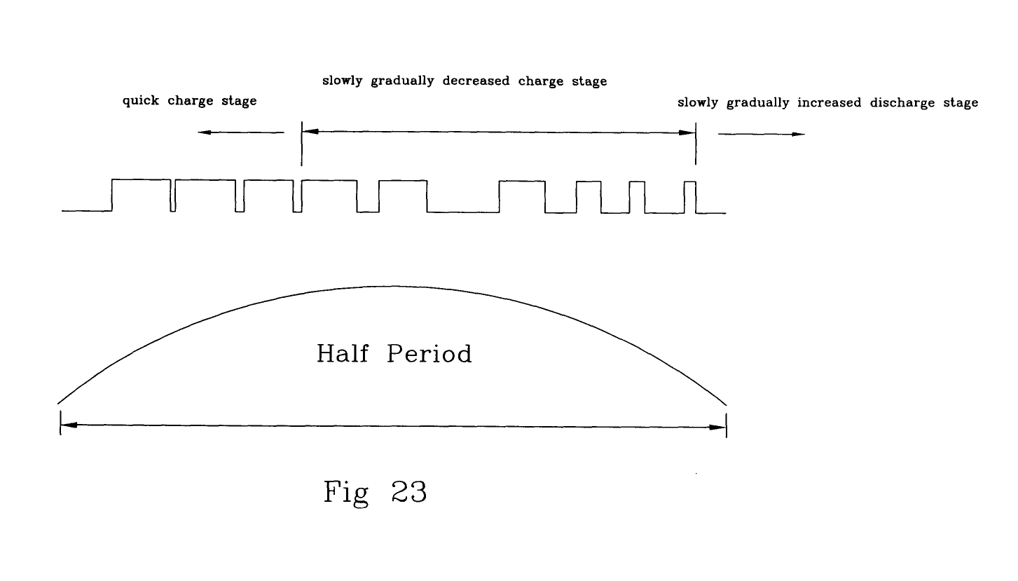

By means of the above rectifying measure, the signal waveform of FIG. 8 is further modified into the pattern of FIG. 21, in which T1 means that Q3 of FIG. 7 is in a high impedance energized state, while T2 means that Q4 of FIG. 7 is in a high impedance energized state. FIG. 10 is modified into the signal waveform of FIG. 22 capable of reducing noise, in which T1 means that Q4 of FIG. 9 is in a high impedance energized state, while T2 means that Q1 of FIG. 9 is in a high impedance energized state. The boosting controlling signal is further changed to make the output waveform nearer to the sinusoidal wave as shown in FIG. 23.

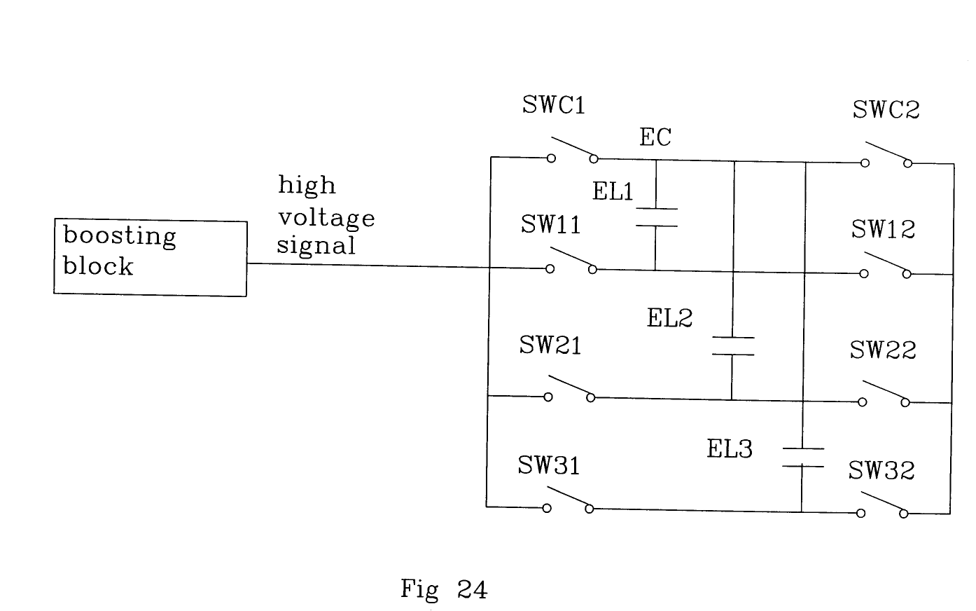

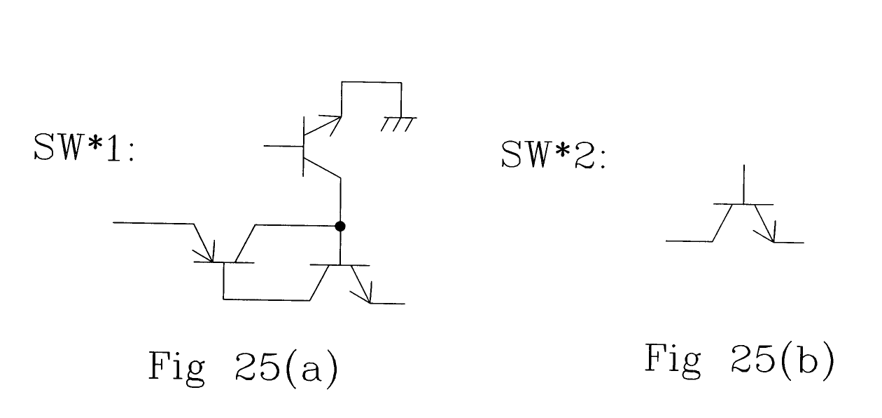

In addition, as shown in FIG. 24, the present invention can be extensively applied to a field necessitating multiple EL to achieve independent control. For example, both the inner and outer panels of a mobile phone need backlight. The low voltage D.C. boosting block is referred to FIG. 1 and the switch structure is as shown in FIG. 25. When SW*1 and SW*2 are in energized state in reverse direction and the SWC* serves as the common point of all the signals, SW11 to SWC1 is in reverse direction or in the same direction and SW21 to SWC1 is in reverse direction or in the same direction. Accordingly, SWC1, SWC2, SW11 and SW12 will form a full-bridge switch. That is, when SWC1 and SW12 are energized, SWC2 and SW11 are cut off. Reversely, when SWC1 and SW12 are cut off, SWC2 and SW11 are energized. Accordingly, alternately, the voltage applied to EL1 will be in a continuous high voltage A.C. pattern. When cutting off EL1, the SWC1 and SW11 and SWC2 and SW12 are adjusted to be in the same direction. Accordingly, a continuous high voltage A.C. signal cycle is formed as shown in FIG. 10. By means of the above measure, multiple EL can be independently controlled and the noise is reduced.

The above embodiments are only used to illustrate the present invention, not intended to limit the scope thereof. Many modifications of the above embodiments can be made without departing from the spirit of the present invention.

What is claimed is:

1. D.C.-A.C. converting circuit capable of increasing boosting efficiency and reducing noise, comprising a boosting section composed of serially connected transistors, inductors and capacitors and an A.C. electronic switch part composed of several transistors and capacitors, said converting circuit being characterized in that the signal for controlling the operation of the transistors is boosted from low potential to high potential so as to speed the operation of the transistors, when cut off, the signal being formed with a negative voltage level pattern or a positive potential level pattern higher than the level for the circuit to operate, whereby the signal on the loading is more efficient.

2. D.C.-A.C. converting circuit as claimed in claim 1, wherein the electronic switchpart of the circuit is replaceable with several diodes, whereby high voltage state will be sequentially generated at two ends of the capacitive loading to form a high voltage A.C. signal and the signal on the loading is also more efficient.

3. D.C.-A.C. converting circuit as claimed in claim 1, wherein resistors and transistors are added to the circuit for reducing the noise, whereby the output waveform of the controlling signal is changed and the noise produced during conversion from D.C. to A.C. is reduced.

4. D.C.-A.C. converting circuit as claimed in claim 1, wherein the constant current of the circuit is controlled to control the discharging time so as to reduce the noise produced during conversion from D.C. to A.C.

5. D.C.-A.C. converting circuit as claimed in claim 1, wherein at the end of the boosting stage, the bandwidth of the controlling signal is changed so as to enhance the smoothness of the waveform and this measure is used in cooperation with the discharge controlling measures of claims 3 and 4 to make the output waveform more optimal.

6. D.C.-A.C. converting circuit as claimed in claim 1, wherein in cooperation with a full-bridge switch, the circuit can independently control multiple EL by means of continuous high voltage A.C. measure and reduce the noise produced during conversion from D.C. to A.C.
